(19) United States
(12) Patent Application Publication
(10) Pub. No.: US 2022/0374735 A1
(43) Pub. Date: Nov. 24, 2022

(54) SYSTEM AND METHOD FOR ENTITY NORMALIZATION AND DISAMBIGUATION

(71) Applicant: Innoplexus AG, Eschborn (DE)

(72) Inventors: Ashwin Rathod, Mahur (IN); Arpan Sheetal, Hazaribag (IN); Nikhil Dadheech, Kapasan (IN)

(21) Appl. No.: 17/325,567

(22) Filed: May 20, 2021

(51) Int. Cl. G06N 5/04; G06N 20/00; G06F 16/28

(52) U.S. Cl. CPC G06N 5/04; G06N 20/00; G06F 16/288

(57) ABSTRACT

A system and method for entity normalization and disambiguation. The system includes a processor configured to extract entity records pertaining to plurality of entities from one or more data sources; identify connections between the entity records based on common attributes between the entity records; generate a knowledge graph including nodes and edges; determine embeddings of each of the plurality of entity records in a vector space based on meta information and similarities between meta information; determine embeddings of each of the plurality of entity records based on the knowledge graph; determine a proximity score between embeddings of two given entity records in the vector space; and disambiguate the two given entity records using a trained supervised model in an event the proximity score is higher than a predefined threshold.

### TECHNICAL FIELD

The present disclosure relates generally to data normalisation; and more specifically, to method and systems for entity normalisation and disambiguation.

### BACKGROUND

Scientific literature is central to the development of science as a whole. Herein, scientific literature includes publications, congresses, clinical trials, patents, grants, guidelines, sponsors, hospitals, HTA, advocacy, thesis and so forth. Moreover, this scientific literature serves as a data source. Scientists reference the data source to indicate supplemental work performed in a particular field, to cite sources of data that is used, and to show how the interpretations integrate with the published knowledge base. Furthermore, several entities may be associated with one or more data source by way of citations, affiliations and so forth. Such entities may include authors, cited authors, university and/or organizations and the likes. With the growth of research activities, author name ambiguity has become a critical issue in management of information at the individual level. Notably, the entities often share the same name or have variants of the same name, making it hard to distinguish the scientific literature of each author. Furthermore, Asian names have a limited set of tokens as a valid name and can have the same last name and first name, making it more difficult to distinguish between their names.

Name disambiguation is critical in many fields of application in order to find the key opinion leaders. For instance, any company who wants to conduct trials for drug discovery related to an indication need to consult a knowledgeable source to know about the current works that are done in that particular field. Herein, the data that is crawled from one or more data sources so as to form entity records is often unstructured. Furthermore, large volume of data in the data source make it difficult to process at scale. Moreover, the attributes and the metadata present across one or more data sources are not only inconsistent but also not normalized and sparse. In addition, no tagged data is available for such a high variance data source. Herein, existing solutions have tackled the normalization problem to an extent but a high number of duplicate clusters can be found. In case of entities with Asian names, large numbers of wrongly merged clusters are present. Mostly, to tackle such issues, manual intervention is needed to make the corrections. However, classification and clustering of the entity still remains an issue in the present systems.

Name disambiguation requires generating a knowledge graph of the entities. There are various citation-author knowledge graphs but these are limited to only one or two data sources and cannot handle large volumes of data. Furthermore, for determination of embeddings, all the currently available methods for generating vectors for any entity lack the correlation information of meta-information that is associated with the entity. This creates problems while training a machine learning model because the model fails to find any separating boundaries between different entities and end up misclassifying. Additionally, clustering algorithms are beneficial in which values of all the attributes of the entities are present that cluster the data points with good accuracy and provide a proximity score. However, when attributes of certain entities are missing, the clustering algorithm is not able to calculate the correct proximity score.

Therefore, in light of the foregoing discussion, there exists a need to overcome the aforementioned drawbacks associated with conventional methods for name disambiguation.

### SUMMARY

The present disclosure seeks to provide a system for entity normalisation and disambiguation. The present disclosure also seeks to provide a method for entity normalisation and disambiguation. An aim of the present disclosure is to provide a solution that overcomes at least partially the problems encountered in prior art.

In one aspect, the present disclosure provides a system for entity normalization and disambiguation, the system comprising a processor configured to:
extract entity records pertaining to plurality of entities from one or more data sources, wherein a given entity record comprises a name of a given entity and attributes of the given entity;
identify connections between the entity records based on common attributes between the entity records;
generate a knowledge graph comprising nodes and edges, wherein entity records are represented as nodes and connections between the entity records are represented as edges;
determine embeddings of each of the plurality of entity records in a vector space based on meta information and similarities between meta information;
determine embeddings of each of the plurality of entity records based on the knowledge graph;
determine a proximity score between embeddings of two given entity records in the vector space; and
disambiguate the two given entity records using a trained supervised model in an event the proximity score is higher than a predefined threshold.

In another aspect, an embodiment of the present disclosure provides a method for entity normalization and disambiguation, wherein the method comprises:
extracting entity records pertaining to plurality of entities from one or more data sources, wherein a given entity record comprises a name of a given entity and attributes of the given entity;
identifying connections between the entity records based on common attributes between the entity records;
generating a knowledge graph comprising nodes and edges, wherein entity records are represented as nodes and connections between the entity records are represented as edges;
determining embeddings of each of the plurality of entity records in a vector space based on meta information and similarities between meta information;
determining embeddings of each of the plurality of entity records based on knowledge graph;
determining a proximity score between embeddings of two given entity records in the vector space; and
disambiguating the two given entity records using a trained supervised model in an event the proximity score is higher than a predefined threshold.

Embodiments of the present disclosure substantially eliminate or at least partially address the aforementioned problems in the prior art, and resolves discrepancies that arise when the same name of the entity is stored in different formats in one or more data sources.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram illustrating a system for entity normalisation and disambiguation, in accordance with an embodiment of the present disclosure; and

FIGS. 2A and 2B collectively illustrate a flow chart depicting steps of a method for entity normalisation and disambiguation, in accordance with an embodiment of the present disclosure

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, the present disclosure provides a system for entity normalization and disambiguation, the system comprising a processor configured to:
extract entity records pertaining to plurality of entities from one or more data sources, wherein a given entity record comprises a name of a given entity and attributes of the given entity;
identify connections between the entity records based on common attributes between the entity records;
generate a knowledge graph comprising nodes and edges, wherein entity records are represented as nodes and connections between the entity records are represented as edges;
determine embeddings of each of the plurality of entity records in a vector space based on meta information and similarities between meta information;
determine embeddings of each of the plurality of entity records based on the knowledge graph;
determine a proximity score between embeddings of two given entity records in the vector space; and
disambiguate the two given entity records using a trained supervised model in an event the proximity score is higher than a predefined threshold.

In another aspect, an embodiment of the present disclosure provides a method for entity normalization and disambiguation, wherein the method comprises:
extracting entity records pertaining to plurality of entities from one or more data sources, wherein a given entity record comprises a name of a given entity and attributes of the given entity;
identifying connections between the entity records based on common attributes between the entity records;
generating a knowledge graph comprising nodes and edges, wherein entity records are represented as nodes and connections between the entity records are represented as edges;
determining embeddings of each of the plurality of entity records in a vector space based on meta information and similarities between meta information;
determining embeddings of each of the plurality of entity records based on knowledge graph;
determining a proximity score between embeddings of two given entity records in the vector space; and
disambiguating the two given entity records using a trained supervised model in an event the proximity score is higher than a predefined threshold.

Pursuant to the embodiments of the present disclosure, the system described herein aims to identify and disambiguate the names of the entities present in one or more data sources. Herein, the present disclosure resolves the discrepancies that arise when the same name of the entity is stored in different formats in one or more data sources. The system described herein enables distinguishing multiple entities if they have the same name. Furthermore, Asian names are also properly differentiated. The present disclosure can process large volumes of data and help in multiple downstream tasks. Additionally, the attributes and metadata present in one or more data sources are made to be consistent and also normalized. Moreover, a fast, reliable and robust system is created that can search the best possible match from a network of entities.

Throughout the present disclosure, the term “data sources” relates to organized or unorganized bodies of digital information regardless of manner in which data is represented therein. Optionally, the data sources are structured and/or unstructured. Optionally, the data sources may be hardware, software, firmware and/or any combination thereof. For example, the data sources may be in form of tables, maps, grids, packets, datagrams, files, documents, lists or in any other form. The data sources include any data storage software and systems, such as, for example, a relational database like IBM, DB2, Oracle 9 and so forth. Moreover, the data sources may include the data in form of text, audio, video, image and/or a combination thereof.

The system for entity normalization and disambiguation comprises a processor configured to extract entity records pertaining to plurality of entities from one or more data sources, wherein a given entity record comprises a name of a given entity and attributes of the given entity. Furthermore, the processor operable to crawl the data sources may be distributed and/or centralized. Notably, the processor is operable to analyze the data sources in order to extract information for creating the entity records.

Throughout the present disclosure, the term “entity record” refers to structured (namely, organized) collection of the data (namely, elements) based on contextual association therebetween relating to an entity. Herein, the entity may be a person, a group of persons, an organization and so forth. Optionally, the data in the entity records may have different data types, string length (namely, number of bits) and size, wherein size of the data refers to memory space consumed in order to store the data. Moreover, the entity records preferably include data in the text format but may also include data in the form of audio, video, image and/or a combination thereof. Notably, the entity records may have scattered, repetitive, inconsistent and/or missing values. For example, the entity records may be in form of tables, maps, grids, packets, datagrams, files, documents, lists or in any other form.

The entity records comprise names of entities and attributes associated with the entities. Specifically, the name of the entity and the attributes of the entity form information included in the entity records. Optionally, the entity names may belong to one or more persons, organizations, objects, domains and so forth. Furthermore, the entity records include fields of information about the names of the entity. The attributes of a given entity include information relating to, but not limited to, educational background, contact details, social media details, professional background, publications by the given entity, field of work and study. Additionally, the attributes of the entity may include data in form of text, audio, video, image and/or a combination thereof. Furthermore, the attributes of the entities may be analyzed in order to obtain unambiguous information pertaining to the name of the entity.

In an embodiment, the entity records are extracted from asset classes in the one or more data sources. Herein, the asset classes include publications, congresses, clinical trials, patents, grants, guidelines, sponsors, hospitals, Health Technology Assessment (HTA), Advocacy, regulatory bodies, thesis and the like.

Optionally, extracting entity records from one or more data sources comprises crawling of data from online available literature and other web content, for example, publications, clinical trials, congresses, patents, grants and so forth.

The processor is configured to identify connections between the entity records based on common attributes between the entity records. Notably, two given entity records referring to one entity may have common attributes therebetween. For example, two entity records with names ‘John H. Smith’ and ‘J H Smith’ may both have a research publication as one of the attribute therein. Therefore, using such common attributes, connections are identified between entity records. Furthermore, the entity records are stored with pre-defined connections as a set of tables with columns and rows. Specifically, the tables comprise information about the entities. Moreover, the entity records with no pre-defined connections are stored in a dictionary format with fields and values.

The processor is configured to generate a knowledge graph comprising nodes and edges, wherein entity records are represented as nodes and connections between the entity records are represented as edges. Herein, the nodes are built on the information relating to the entity records and the connections are defined between the nodes based on identified connections and entity attributes thereof. In an example, all the entity records in a publication are interlinked in the knowledge graph. Furthermore, the entity records may be compared to nearby names and initials of the entities, instead of completely different names of the entities.

Optionally, creation of the nodes depends on the number of connections connected to the entity record representing in the nodes. Furthermore, information regarding the closeness of the nodes to each other is stored. Additionally, the node which has the most control over flow between the nodes is determined. Finally, the most important node is identified based on number and weightage of the connections therebetween. Hence, after processing and structuring the data, nodes and edges are built and stored as tagged data in ‘Tag:ID’ structure. Herein, tagged data is used for comparison between two given entity records and the same or different tag is present against all pairs of data points. In this regard, the tagged data may be created manually. However, this method is not scalable and not a speedy option. Furthermore, a positive and a negative data set may be created by checking on the name of the entity and the attributes of the entity. For example, in case the name, affiliation and country of two given entity records are same, then the two given entity records are similar entities, otherwise different. Herein, the creation of positive and negative data is scalable and has the potential to create millions of data points. However, the data has low variation and different representation from population. Although, the disambiguation of initial names is scalable and may lead to creation of millions of data points, however the data has low variation and has a different representation thereof. For example, ‘J Marshall’ of ‘California University, USA’ may or may not be the same entity when compared to ‘J Marshall’ of ‘California University, USA’.

Optionally, a heuristic approach may be used to group similar entities and then use manual validators to select duplicate records out of similar records. Herein, a similar entity records is created to build an initial level of clusters for the dataset. Furthermore, a processor is made which takes any name of an entity as the input, calculates all the permutations and returns all the possible entities against the permuted name of the entity. For each of the profiles, the latest affiliation country, year range of the research activity, top hundred research activity keywords and the research activity distribution are displayed. In particular, whenever a search is made, the research activity source IDs are captured for the ones which were merged. Herein, profiles which were missed are grouped under negative data with respect to those merged. Furthermore, in case negative data points in the previous search are converted to positive data points on the next search, timestamps may be stored against each searched name of the entity. Beneficially, the timestamp helps in selection the final representation of the tag between any two data points. Notably, the data set covers the case of splitting. Herein, any cluster which was previously wrongly merged and is split later again during validation.

In an embodiment, 220 million entity records are converted into the knowledge graph. Herein, the knowledge graph consists of nodes and edges and the total number of nodes in the final knowledge graphs are more than 240 million with approximately 1.772 billion connections therebetween. Conventionally, the knowledge graphs were limited only to one or two data sources. In the present disclosure, the information in the knowledge graph is taken from an extensive list of data sources in any given domain.

In an embodiment, data of an entity from online available literature and other web content like profile pages, scientific articles, patents, news and so forth is crawled and stored as entity record in the form of a document. Particularly, one of the documents from the data source is identified as a citation, which is the main document to which the entities belong such as publication, clinical trial, congresses, patents and so forth. Herein, the entity is an author or co-author of the citation. Additionally, nodes are identified for the document. Herein, the nodes are: year of publication of the citation, keywords from the citation, journal or publisher that the citation belongs to, sponsor of the citation, authors and/or co-authors of the citation, organization to which the entities are related and the country to which the entities belong. Furthermore, the nodes are provided with a node ID and classified into the relevant asset class along with the properties of the node. Additionally, the node ID and timestamp may be used to finalize the final tag. Subsequently, a structure similar to Table 1 is observed

TABLE 1

| | | | Relevant | |
|---|---|---|---|---|
| S. No. | Node | Node id | Asset Class | Node properties |
| 1 | clinical_trials_citation | clinical_id | clinical | [‘public_title’, ‘start_year’, ‘start_date’, |
| | | | trials | ‘oversight_info.authority’, ‘therapy_type’] |
| 2 | sponsor | sponsors.collaborator.normalized_name | clinical | |
| | | | trials | |
| 3 | sponsor_country | sponsors.lead_sponsor.countries | clinical | |
| | | | trials | |
| 4 | alias | authors.author_name | clinical | [‘authors.normalize_name’, ‘authors.role’, |
| | | | trials | ‘authors.affiliation’] |
| 5 | organization | authors.affiliation | clinical | [‘authors.affiliations.countries', |
| | | | trials | ‘authors.affiliations.normalized_name’] |
| 6 | language | language | clinical | |
| | | | trials | |
| 7 | source | source | clinical | [‘source_url’] |
| | | | trials | |
| 8 | mesh_term1 | keyword | clinical | |
| | | | trials | |
| 9 | mesh_term2 | condition_mesh_terms | clinical | |
| | | | trials | |
| 10 | hospital_citation | innoplexus_id | hospitals | [‘body_name’, ‘committee’, ‘classification.TA’, |
| | | | | ‘classification.indications'] |
| 11 | organization | authors.affiliation | hospitals | [‘authors.affiliations.countries'] |
| 12 | alias | authors.normalize_name | hospitals | [‘authors.kol_name’, ‘authors.country’] |
| 13 | country | authors.affiliations.countries | hospitals | |
| 14 | congress_citation | congress_id | congresses | [‘congress_TA’, ‘congress_venue.country’, |
| | | | | ‘congress_venue.city’, ‘congress_date’, |
| | | | | ‘congress_name’, ‘year’, ‘title’] |
| 15 | alias | authors.author_name | congresses | [‘authors.kol_name’ ‘authors.designation’, |
| | | | | ‘authors.country’, ‘authors.kol_title’] |
| 16 | organization | authors.affiliations.normalized_name | congresses | [‘authors.affiliations.countries'] |
| 17 | source | source | congresses | [‘source_url’] |
| 18 | country | authors.affiliations.countries | congresses | |
| 19 | hta_citation | body_name | HTA | [‘innoplexus_id’] |
| 20 | mesh_terms1 | classification.indications | HTA | |
| 21 | mesh_terms2 | classification.TA | HTA | |
| 22 | alias | authors.author_name | HTA | [‘authors.designation’, ‘authors.kol_name’, |
| | | | | ‘authors.normalize_name’, ‘authors.email’, |
| | | | | ‘authors.source_url’] |
| 23 | organization | authors.affiliation | HTA | [‘authors.affiliations.normalized_name’] |
| 24 | country | authors.affiliations.countries | HTA | |
| 25 | regulatory_bodies_citation | body_name | regulatory | [‘innoplexus_id’, ‘committee’] |
| | | | bodies | |
| 26 | mesh_terms1 | classification.indications | regulatory | |
| | | | bodies | |
| 27 | mesh_terms2 | classification.TA | regulatory | |
| | | | bodies | |
| 28 | alias | authors.author_name | regulatory | [‘authors.kol_name’ ‘authors.normalize_name’, |
| | | | bodies | ‘authors.email’, |
| | | | | ‘authors.source_url’/‘authors.speciality’] |
| 29 | organization | authors.affiliation | regulatory | [‘authors.affiliations.normalized_name’] |
| | | | bodies | |
| 30 | country | authors.affiliations.countries | regulatory | |
| | | | bodies | |
| 31 | societies_citation | body_name | societies | [‘innoplexus_id’, ‘committee’] |
| 32 | mesh_terms1 | classification.indications | societies | |
| 33 | mesh_terms2 | classification.TA | societies | |
| 34 | alias | authors.author_name | societies | [‘authors.kol_name’ ‘authors.normalize_name’, |
| | | | | ‘authors.email’, |
| | | | | ‘authors.source_url’/‘authors.speciality’, |
| | | | | ‘authors.phone’] |
| 35 | organization | authors.affiliation | societies | [‘authors.affiliations.normalized_name’] |
| 36 | country | authors.affiliations.countries | societies | |
| 37 | new_thesis_citation | innoplexus_id | New Thesis | [‘title’, ‘date’, ‘download_url’, ‘source_url’, |
| | | | | ‘degree.degree_name’, ‘degree.degree_type’] |
| 38 | mesh_terms1 | keywords | New Thesis | |
| 39 | alias | authors.author_name | New Thesis | [‘authors.normalize_name’, ‘authors.author_type’, |
| | | | | ‘authors.department’, ‘authors.title’, |
| | | | | ‘authors.qualification’] |
| 40 | organization | authors.affiliation | New Thesis | [‘authors.affiliations.normalized_name’] |
| 41 | country | authors.affiliations.countries | New Thesis | |
| 42 | language | language | New Thesis | |
| 43 | publisher | publisher | New Thesis | |
| 44 | guideline_citation | guideline_id | Guidelines | [‘title’, ‘created_at’, ‘data_source’, ‘source_url’, |
| | | | | ‘date’, ‘year’, ‘issuing_body’, ‘about’, |
| | | | | ‘guideline_country’, ‘issuing_body_list’, |
| | | | | ‘also_published_as.source’, |
| | | | | ‘also_published_as. source_url’, ‘link’] |
| 45 | mesh_terms1 | classification.indications | Guidelines | |
| 46 | mesh_terms2 | classification.TA | Guidelines | |
| 47 | mesh_terms3 | gene | Guidelines | |
| 48 | mesh_terms4 | drug | Guidelines | |
| 49 | mesh_terms5 | mentions.term | Guidelines | |
| 50 | alias | authors.author_name | Guidelines | [‘authors.normalize_name’, ‘authors.designation’, |
| | | | | ‘authors.speciality’, ‘authors.title’, |
| | | | | ‘authors.country’] |
| 51 | organization | authors.affiliation | Guidelines | [‘authors.affiliations.normalized_name’] |
| 52 | country | authors.affiliations.countries | Guidelines | |
| 53 | citation | publication_id | Publications | [‘article_title’, ‘DOI’, ‘year’, ‘issn’, ‘pmc_id’, |
| | | | | ‘source_url’] |
| 54 | journal | journal_title | Publications | [‘std_journal_title’, ‘impact_factor’] |
| 55 | language | language | Publications | |
| 56 | alias | authors.author_name | Publications | [‘authors.ForeName’,/‘authors.LastName’] |
| 57 | organization | authors, author_affiliation | Publications | [‘authors.affiliation’] |
| 58 | mesh_term1 | keywords | Publications | |
| 59 | mesh_term2 | substances | Publications | |
| 60 | mesh_term3 | mesh_terms | Publications | |
| 61 | sponsor_name | name | Sponsor | [‘mongo_id’, ‘sponsor_id’, ‘innoplexus_id’] |
| 62 | sponsor_name_alias | aliases | Sponsor | [‘mongo_id’, ‘innoplexus_id’, ‘name’] |
| 63 | authors_affiliation | authors.affiliation | Advocacy | [‘authors.affiliations.id’, |
| | | | | ‘authors.affiliations.normalized_name’] |
| 64 | authors_affiliations_countries | authors.affiliations.countries | Advocacy | |
| 65 | authors_author_name | authors.author_name | Advocacy | [‘authors.address', ‘authors.author_id’, |
| | | | | ‘authors.email’, ‘authors.new_author_id’, |
| | | | | ‘authors.normalize_name’, |
| | | | | ‘authors.source_url’/‘authors.speciality’, |
| | | | | ‘authors.kol_name’, ‘authors.kol_education’, |
| | | | | ‘authors.kol_title’] |
| 66 | authors_country | authors.country | Advocacy | |
| 67 | authors_designation | authors.designation | Advocacy | |
| 68 | body_name | body_name | Advocacy | [‘committee’, ‘innoplexus_id’] |
| 69 | classification_TA | classification.TA | Advocacy | |
| 70 | classification_indications | classification.indications | Advocacy | |

Furthermore, connection between the two nodes is established and classified into the relevant asset class as shown in Table 2

TABLE 2

| | | | | Relevant |
|---|---|---|---|---|
| S. No. | Node 1 | Node2 | Relationship | Asset Class |
| 1 | clinical_trials_citation | sponsor | sponsored_by | clinical |
| | | | | trials |
| 2 | sponsor | sponsor_country | location | clinical |
| | | | | trials |
| 3 | alias | clinical_trials_citation | authored | clinical |
| | | | | trials |
| 4 | organization | alias | research_scientist | clinical |
| | | | | trials |
| 5 | language | clinical_trials_citation | | clinical |
| | | | | trials |
| 6 | source | clinical_trials_citation | child_citation | clinical |
| | | | | trials |
| 7 | mesh_term1 | clinical_trials_citation | related_citation | clinical |
| | | | | trials |
| 8 | mesh_term2 | clinical_trials_citation | related_citation | clinical |
| | | | | trials |
| 9 | hospital_citation | alias | author | hospitals |
| 10 | alias | organization | related_organization | hospitals |
| 11 | country | organization | has_organization | hospitals |
| 12 | congress_citation | alias | author | congresses |
| 13 | source | congress_citation | child_citation | congresses |
| 14 | alias | organization | related_organization | congresses |
| 15 | organization | country | location | congresses |
| 16 | hta_citation | alias | author | HTA |
| 17 | mesh_terms1 | hta_citation | related_citation | HTA |
| 18 | mesh_terms2 | hta_citation | related_citation | HTA |
| 19 | alias | organization | related_organization | HTA |
| 20 | organization | country | location | HTA |
| 21 | regulatory_bodies_citation | alias | author | regulatory |
| | | | | bodies |
| 22 | mesh_terms1 | regulatory_bodies_citation | related_citation | regulatory |
| | | | | bodies |
| 23 | mesh_terms2 | regulatory_bodies_citation | related_citation | regulatory |
| | | | | bodies |
| 24 | alias | organization | related_organization | regulatory |
| | | | | bodies |
| 25 | organization | country | location | regulatory |
| | | | | bodies |
| 26 | societies_citation | alias | author | societies |
| 27 | mesh_terms1 | societies_citation | related_citation | societies |
| 28 | mesh_terms2 | societies_citation | related_citation | societies |
| 29 | alias | organization | related_organization | societies |
| 30 | organization | country | location | societies |
| 31 | new_thesis_citation | alias | author | New Thesis |
| 32 | mesh_terms1 | new_thesis_citation | related_citation | New Thesis |
| 33 | alias | organization | related_organization | New Thesis |
| 34 | organization | country | location | New Thesis |
| 35 | language | new_thesis_citation | | New Thesis |
| 36 | publisher | new_thesis_citation | published | New Thesis |
| 37 | guideline_citation | alias | author | Guidelines |
| 38 | mesh_terms1 | guideline_citation | related_citation | Guidelines |
| 39 | mesh_terms2 | guideline_citation | related_citation | Guidelines |
| 40 | mesh_terms5 | guideline_citation | related_citation | Guidelines |
| 41 | mesh_terms3 | guideline_citation | related_citation | Guidelines |
| 42 | mesh_terms4 | guideline_citation | related_citation | Guidelines |
| 43 | alias | organization | related_organization | Guidelines |
| 44 | organization | country | location | Guidelines |
| 45 | journal | citation | child_citation | Publications |
| 46 | citation | alias | author | Publications |
| 47 | mesh_term1 | citation | related_citation | Publications |
| 48 | mesh_term3 | citation | related_citation | Publications |
| 49 | mesh_term2 | citation | related_citation | Publications |
| 50 | language | citation | | Publications |
| 51 | alias | organization tion | related_organization | Publications |
| 52 | sponsor_name | sponsor_name_alias | also_known_as | Sponsor |
| 53 | authors_author_name | authors_affiliation | has_affiliation | Advocacy |
| 54 | authors_affiliations_countries | authors_author_name | | Advocacy |
| 55 | authors_country | authors_author_name | | Advocacy |
| 56 | authors_designation | authors_author_name | | Advocacy |
| 57 | body_name | authors_author_name | associated_author | Advocacy |
| 58 | classification_TA | body_name | | Advocacy |
| 59 | classification_indications | body_name | | Advocacy |

The processor is configured to determine embeddings of each of the plurality of entity records in a vector space based on the knowledge graph. Herein, the embeddings are low-dimensional continuous vector representations of each of the plurality of entity records in the knowledge graph, which preserves the structure of the entity records throughout and simplify its use in the present disclosure. Currently, all the available methods for generating vectors for any entity lack correlation information of meta information that is associated with the entity record. Furthermore, every representation using standard methods does not ensure the entity records with similar meta information are positioned at such points so that the cosine distance between them is close to zero. Henceforth, in the present disclosure, the vector space representation of the entity records is generated in three different steps to include different variations as per the metainformation available. Additionally, these variations include similarity between metainformation of two input entity records, vector representation of the metainformation and the vector representation of the nodes corresponding to the metainformation of the author profile. Herein, the metainformation includes name, affiliated organization, connections, the data source, references, coauthors, published year, country etc. The processor may further determine embeddings each of the plurality of entity records in a vector space based on meta information and similarities between meta information.

Optionally, the processor is configured to cluster multiple entity records using one or more clustering algorithms, wherein embeddings of the entity records in a given cluster are compared for disambiguation. Specifically, community detection clustering algorithms such as Label Propagation clustering algorithm (LPA) and Louvain Modularity clustering algorithm are used to produce pure clusters. Herein, community detection clustering algorithms are used to detect clusters with similar attributes and extract the entity records for varied reasons. Particularly, the LPA is a fast-clustering algorithm for finding communities in the knowledge graph. Furthermore, the LPA detects these communities using the nodes and edges alone as its guide, and does not require a predefined objective function or prior information about the communities. Additionally, the Louvain Modularity clustering algorithm is a hierarchical clustering algorithm, that recursively merges communities into a single node and is able to detect communities in large networks. Subsequently, the present disclosure procures pure clusters whose population is identical after application of the clustering algorithms as mentioned. Specifically, these pure clusters contain the names of the entities and their attributes from one or more data sources.

In an embodiment, the system the processor employs, a machine learning model, to determine embeddings of each of the plurality of entity records based on similarity embeddings. word embeddings and graph embeddings of the plurality of entity records. Herein, the word embeddings are techniques where individual words are represented as real-valued vectors in a predefined vector space. Particularly, the word embeddings are trained using FastText machine learning model. Herein, this machine learning model helps capture the meaning of shorter names of a given entity and allows the embeddings to understand suffixes and prefixes.

In an embodiment, the machine learning model for word embeddings identifies the attributes and performs character level embedding for training and testing of the machine learning model. Herein, character level embedding is performed to deal with unknown words. Furthermore, the character level embedding uses one-dimensional convolutional neural network (1D-CNN) to find numeric representation of words by looking at their character-level compositions. In one instance, organization is an attribute of dimension 10, which is a list of organizations to which the entity is affiliated to. The examples of organization include ‘University of California Berkeley’, ‘Harvard University’ and so forth. In another instance, fingerprint is an attribute of dimension 30. The examples of fingerprint include, ‘Venous Insufficiency’, ‘Leech infestation’, ‘Retinal venous engorgement’ and so forth. In yet another instance, coauthors of the same citation have a dimension of 20, which is a list of all the authors who worked on the study along with the main author of the citation.

Optionally, the graph embedding is used to transform the nodes, edges and their attributes into a lower dimension vector space while maximally preserving properties like graph structure and information related to the entity records. Herein, the graph embeddings are trained using the ComplEx machine learning model using Pytorch BigGraph library (PBG). The PBG is designed for very large graphs, making the PBG suitable for the present disclosure having a graph size of 240 million nodes and 1.77 billion connections. Additionally, the machine learning model performs multithreaded computation on each machine and batch negative sampling at a very high speed. Subsequently, the format of edges for the training is

“START:ID” “END:ID” “RELATION:TYPE”

Furthermore, the dimension of the vector representation for each entity is

Name of the entity node 1: 50 dimension vector

Name of the entity node 1: 50 dimension vector

In one instance, a first entity record for an entity named ‘Jun Li’ may comprise the organization ‘University of Technology Sydney’. Additionally, a second entity record for an entity named ‘Dr. J Li’ may comprise the organization ‘University of Technology Sydney’. Consequently, the machine learning model should have similar embeddings for both the entity records even with different names of the entities. In another instance, a third entity record for an entity named ‘Jun Li’ may comprise the organization ‘University of Pennsylvania’. Furthermore, a fourth entity record for an entity named ‘Jun Li’ may comprise the organization ‘University of Western Australia’. Consequently, the machine learning model should have different embeddings for both the entity records even with same names of the entities.

In an embodiment, the machine learning model employs neighborhood aggregation and convolutional encoders to determine embeddings of each of the plurality of entity records. Particularly, the word convolution is used because they represent a node as a function of its surrounding neighborhood. Furthermore, in the encoding phase of the convolutional encoder, the neighborhood aggregation techniques build up the representation for a node in an iterative, or recursive fashion. First, the node embeddings are initialized to be equal to the input node attributes. Then at each iteration of the encoder algorithm, nodes aggregate the embeddings of their neighbors, using an aggregation function that operates over sets of vectors. After this aggregation, every node is assigned a new embedding, equal to its aggregated neighborhood vector combined with its previous embedding from the last iteration. Finally, this combined embedding is fed through a dense neural network layer and the process repeats. As the process iterates, the node embeddings contain information aggregated from further and further reaches of the graph. However, the dimensionality of the embeddings remains constrained as the process iterates, so the encoder is forced to compress all the neighborhood information into a low dimensional vector. After multiple iterations the process terminates and the final embedding vectors are output as the node representations.

The processor is configured to determining a proximity score between embeddings of two given entity records in the vector space. Herein, the proximity score is the probability of the two given entity records being similar. Conventionally, the proximity score is determined with a good accuracy when all the fields of the entity record are present. However, if some of the values are missing, then the processor fails to recognize the correct proximity score for similar or dissimilar entities. In the present disclosure, when the two given entity records are similar, then the output is ‘Yes’ and when the two given entity records are dissimilar, then the output is ‘No’. Additionally, a weightage is assigned to the encoded outputs, wherein ‘Yes’ is encoded as ‘1’ and ‘No’ is encoded as ‘−1’. Subsequently, a confidence score is calculated to confirm the correctness of the similarity score. Hence, the proximity score is a product of encoded output and the confidence score. For instance, consider the confidence score is 0.78 and encoded output is ‘Yes’, the proximity score calculated is 1*0.78. In another instance, consider the confidence score is 0.97 and the encoded output is ‘No’, the proximity score calculated is −1*0.97.

The processor is configured to disambiguate the two given entity records using a trained supervised model in an event the proximity score is higher than a predefined threshold. Herein, a binary classification model is used as the trained supervised model. Furthermore, the pure clusters as described in the present disclosure are further converted into comparison examples for the preparation of the training and testing data. Notably, the clusters used for training and testing data are completely independent. Hence, the comparison examples prepared for the training and testing data are also independent from each other.

In an example, a first cluster has an entity record with first entity name ‘John F. Marshall’ and its variations as shown in Table 3. Similarly, a second cluster has an entity record with second entity name ‘John M. Marshall’ and its variations as shown in Table 3. Notably, the processor compares the names of the entities of the first cluster and the second cluster. Subsequently, the names of the first entity of the first cluster are compared with the names of the first entity in the first cluster. Additionally, the names of the second entity of the second cluster are compared with the names of the second entity in the second cluster. Furthermore, the entity names of the first cluster and the second cluster are compared with each other. Consequently, if the compared names of the entities belong to the same cluster then they correspond to the ‘Yes’ class as shown in Table 4. Additionally, if the compared names of the entities do not belong to the same cluster then they correspond to the ‘No’ class. Herein, the ‘Yes’ and ‘No’ output is the comparison data.

TABLE 3

| CLUSTER 1 | CLUSTER 2 |
|---|---|
| John Marshall | John Marshall |
| John F. Marshall | John M. Marshall |
| J Marshall | J M. Marshall |
| J F Marshall | J Marshall |

TABLE 4

| Author 1 | Author 2 | If same |
|---|---|---|
| John Marshall | John F. Marshall | Yes |
| (Cluster1) | (Cluster1) | |
| John Marshall | J Marshall | Yes |
| (Cluster1) | (Cluster1) | |
| John F. Marshall | J Marshall | Yes |
| (Cluster1) | (Cluster1) | |
| John Marshall | John M. Marshall | Yes |
| (Cluster2) | (Cluster2) | |
| John Marshall | J M. Marshall | Yes |
| (Cluster2) | (Cluster 2) | |
| John M. Marshall | J M. Marshall | Yes |
| (Cluster2) | (Cluster 2) | |
| John Marshall | John Marshall | No |
| (Cluster1) | (Cluster2) | |
| John Marshall | John M. Marshall | No |
| (Cluster1) | (Cluster2) | |
| John Marshall | J M. Marshall | No |
| (Cluster1) | (Cluster 2) | |
| John F. Marshall | John Marshall | No |
| (Cluster1) | (Cluster2) | |
| J Marshall | John Marshall | No |
| (Cluster1) | (Cluster2) | |
| J Marshall | John M. Marshall | No |
| (Cluster1) | (Cluster2) | |
| J Marshall | J M. Marshall | No |
| (Cluster1) | (Cluster 2) | |

Furthermore, after identification of comparison data, based on the metainformation attached to each entity record, one can convert this information into vectors. Moreover, the final training of the binary classification model has to be done using the vector representation of each entity from column and concatenating it with the vector representation of the opposite entity in column 2 and then calculate the similarity. Hence, the binary classification model needs to predict the similarity of every two entity records. Finally, each comparison is transformed into a vector representation to train the binary classification model. Notably, the trained supervised model uses 250,000 unique clusters for the training data. Furthermore, 50,000 unique clusters are used for the test data. Additionally, 5.4 million comparisons are performed for the training data and 0.7 million comparisons are performed for the test data.

In an embodiment, the trained supervised model is trained using at least one of: RandomForest Classification Model, XGBoost Classifier, Logistic Regression Classifier, Neural Net. Herein, the RandomForest Classification Model uses Gini impurity as a function to measure the quality of split between the training data and the test data. Additionally, the XGBoost Classifier has a learning rate of 0.3 with a maximum depth of 6 and uses gbtree as a booster. Furthermore, the Logistic Regression Classifier has hundred maximum iterations when Sigmoid function is employed as the activation function. Moreover, the tolerance for stopping criteria is e-4. Hence, the different vector representations are combined to form a final vector representation of the two given entity records. Finally, the present disclosure comprises storing the disambiguated entity records in a data repository.

The system further comprises a data repository for storing the disambiguated entity records. Herein, the term “data repository” as used herein relates to an organized body of digital information regardless of the manner in which the data or the organized body thereof is represented. Optionally, the data repository may be hardware, software, firmware and/or any combination thereof. For example, the organized body of related data may be in the form of a table, a map, a grid, a packet, a datagram, a file, a document, a list or in any other form. The data repository includes any data storage software and systems, such as, for example, a relational database like IBM DB2 and Oracle 9.

In an embodiment, reinforcement learning may be used to improve models on each training iteration. The main issue faced by the present disclosure is the distribution and availability of meta information which keeps on changing with time. Consequently, to keep the supervised binary classification model updated with the distribution and variation of the incoming data, the parameters need to be updated with time. Notably, the tagged data from the validators may be used as a feedback loop for the binary classification model for future predictions. Furthermore, the model may be retrained with every validation iteration and making sure that the accuracy stays the same or increases which may help the model to improve with time. Additionally, by including new data, the binary classification model redistributes feature weightage and its importance in prediction. Herein, any prediction that the binary classification model may have missed or predicted wrongly is corrected. Subsequently, in this typical form of reinforcement learning, the environment is the complete normalization system. Furthermore, the prediction of the binary classification model is observed to be same or different. Additionally, agent is the model that predicts. Interpreter is the tagged data points of the validators. Consequently, if the prediction is the same, the agent is rewarded and in case the prediction is different, then the model learns on how to improve.

Various embodiments and variants disclosed in the present disclosure apply mutantis mutandis to the method.

Optionally, the method comprises clustering multiple entity records using one or more clustering algorithms, wherein embeddings of the entity records in a given cluster are compared for disambiguation.

Optionally, the method comprises employing, a machine learning model, to determine embeddings of each of the plurality of entity records based on similarity embeddings, word embeddings and graph embeddings of the plurality of entity records.

More optionally, the machine learning model employs neighborhood aggregation and convolutional encoders to determine embeddings of each of the plurality of entity records.

Optionally, the trained supervised model is a binary classification model.

Optionally, the trained supervised model is trained using at least one of: RandomForest Classification Model, XGBoost Classifier, Logistic Regression Classifier, Neural Net.

Optionally, the method comprises storing the disambiguated entity records in a data repository.

### DETAILED DESCRIPTION OF THE DRAWINGS

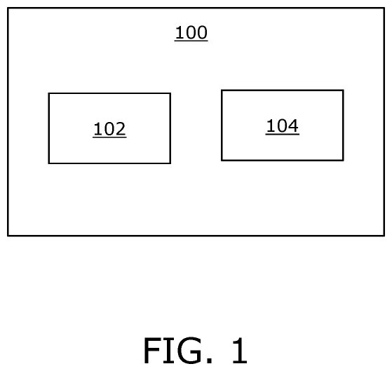

Referring to FIG. 1, there is shown a block diagram illustrating a system 100 for entity normalisation and disambiguation, in accordance with an embodiment of the present disclosure. The system 100 comprises a processor 102 configured to:
extract entity records pertaining to plurality of entities from one or more data sources, wherein a given entity record comprises a name of a given entity and attributes of the given entity;
identify connections between the entity records based on common attributes between the entity records;
generate a knowledge graph comprising nodes and edges, wherein entity records are represented as nodes and connections between the entity records are represented as edges;
determine embeddings of each of the plurality of entity records in a vector space based on meta information and similarities between meta information;
determine embeddings of each of the plurality of entity records based on the knowledge graph
determine a proximity score between embeddings of two given entity records in the vector space; and
disambiguate the two given entity records using a trained supervised model in an event the proximity score is higher than a predefined threshold.

The system further comprises a data repository 104 for storing the disambiguated entity records.

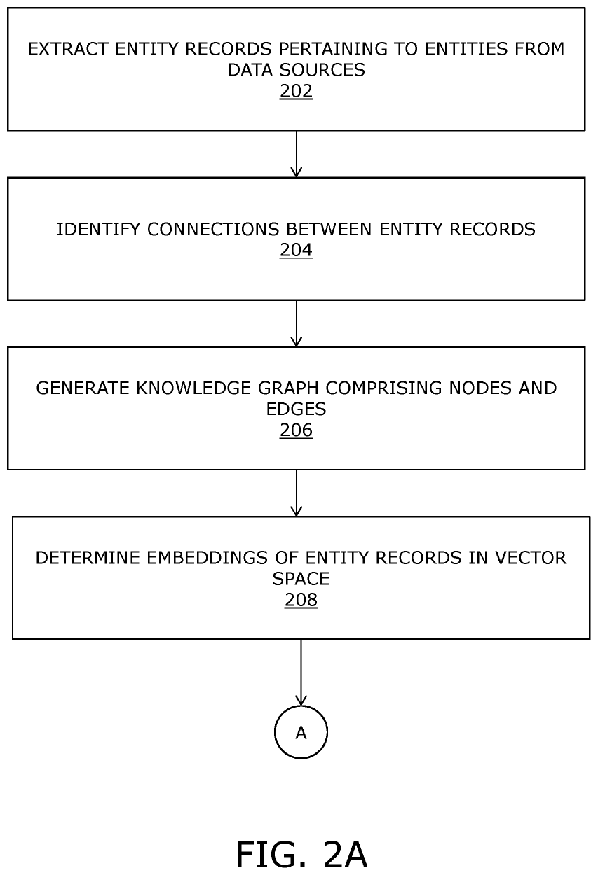

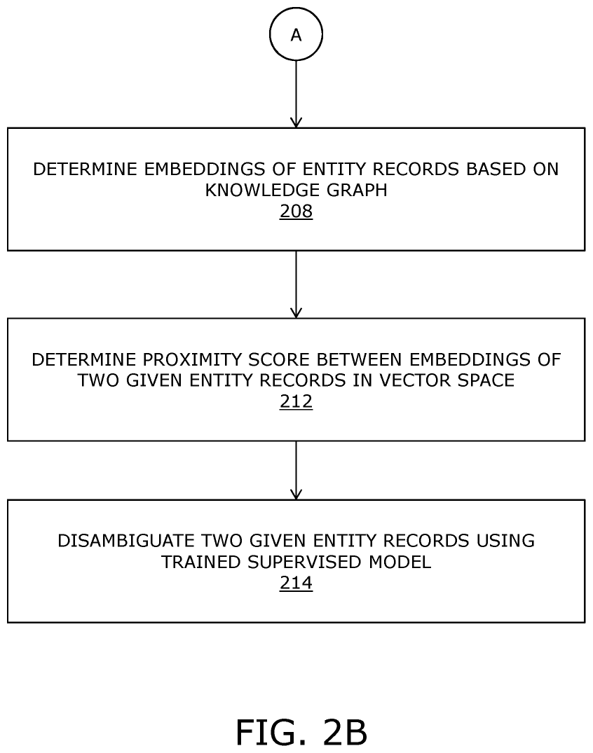

Referring to FIGS. 2A and 2B, collectively illustrate a flow chart depicting steps of a method for entity normalisation and disambiguation, in accordance with an embodiment of the present disclosure. At step 202, entity records pertaining to plurality of entities are extracted from one or more data sources, wherein a given entity record comprises a name of a given entity and attributes of the given entity. At step 204, connections between the entity records are identified based on common attributes between the entity records. At step 206, a knowledge graph comprising nodes and edges is generated, wherein entity records are represented as nodes and connections between the entity records are represented as edges. At step 208, embeddings of each of the plurality of entity records are determined in a vector space based on meta information and similarities between meta information. At step 210, embeddings of each of the plurality of entity records are determined based on knowledge graph. At step 212, a proximity score between embeddings of two given entity records in the vector space is determined. At step 214, the two given entity records are disambiguated using a trained supervised model in an event the proximity score is higher than a predefined threshold.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for entity normalization and disambiguation, the system comprising a processor configured to:
extract entity records pertaining to plurality of entities from one or more data sources, wherein a given entity record comprises a name of a given entity and attributes of the given entity;
identify connections between the entity records based on common attributes between the entity records;
generate a knowledge graph comprising nodes and edges, wherein entity records are represented as nodes and connections between the entity records are represented as edges;
determine embeddings of each of the plurality of entity records in a vector space based on meta information and similarities between meta information;
determine embeddings of each of the plurality of entity records based on the knowledge graph;
determine a proximity score between embeddings of two given entity records in the vector space; and
disambiguate the two given entity records using a trained supervised model in an event the proximity score is higher than a predefined threshold.

2. A system of claim 1, wherein the processor is configured to cluster multiple entity records using one or more clustering algorithms, wherein embeddings of the entity records in a given cluster are compared for disambiguation.

3. A system of claims 1, wherein the processor employs, a machine learning model, to determine embeddings of each of the plurality of entity records based on similarity embeddings, word embeddings and graph embeddings of the plurality of entity records.

4. A system of claim 3, wherein the machine learning model employs neighborhood aggregation and convolutional encoders to determine embeddings of each of the plurality of entity records.

5. A system of claim 1, wherein the trained supervised model is a binary classification model.

6. A system of claim 1, wherein the trained supervised model is trained using at least one of: RandomForest Classification Model, XGBoost Classifier, Logistic Regression Classifier, Neural Net.

7. A system of claim 1, wherein the system further comprises a data repository for storing the disambiguated entity records.

8. A method for entity normalization and disambiguation, wherein the method comprises:
extracting entity records pertaining to plurality of entities from one or more data sources, wherein a given entity record comprises a name of a given entity and attributes of the given entity;
identifying connections between the entity records based on common attributes between the entity records;
generating a knowledge graph comprising nodes and edges, wherein entity records are represented as nodes and connections between the entity records are represented as edges;
determining embeddings of each of the plurality of entity records in a vector space based on meta information and similarities between meta information;
determining embeddings of each of the plurality of entity records based on knowledge graph;
determining a proximity score between embeddings of two given entity records in the vector space; and
disambiguating the two given entity records using a trained supervised model in an event the proximity score is higher than a predefined threshold.

9. A method of claim 8, wherein the method comprises clustering multiple entity records using one or more clustering algorithms, wherein embeddings of the entity records in a given cluster are compared for disambiguation.

10. A method of claim 8, wherein the method comprises employing, a machine learning model, to determine embeddings of each of the plurality of entity records based on similarity embeddings, word embeddings and graph embeddings of the plurality of entity records.

11. A method of claim 10, wherein the machine learning model employs neighborhood aggregation and convolutional encoders to determine embeddings of each of the plurality of entity records.

12. A method of claim 8, wherein the trained supervised model is a binary classification model.

13. A method of claim 8, wherein the trained supervised model is trained using at least one of: RandomForest Classification Model, XGBoost Classifier, Logistic Regression Classifier, Neural Net.

14. A method of claim 8, wherein the method comprises storing the disambiguated entity records in a data repository.
